(19) United States
(12) Patent Application Publication
(10) Pub. No.: US 2025/0028017 A1
(43) Pub. Date: Jan. 23, 2025

(54) METHOD AND APPARATUS FOR POSITIONING USING OPTICAL SIGNAL

(71) Applicants: Samsung Electronics Co., Ltd., Suwon-si (KR); INCHEON NATIONAL UNIVERSITY RESEARCH & BUSINESS FOUNDATION, Incheon (KR)

(72) Inventors: Chul Joon HEO, Suwon-si (KR); Hyunchae CHUN, Incheon (KR); Minseok YOO, Incheon (KR); Kyung Bae PARK, Suwon-si (KR); Younhee LIM, Suwon-si (KR)

(73) Assignees: Samsung Electronics Co., Ltd., Suwon-si (KR); INCHEON NATIONAL UNIVERSITY RESEARCH & BUSINESS FOUNDATION, Incheon (KR)

(21) Appl. No.: 18/742,281

(22) Filed: Jun. 13, 2024

(30) Foreign Application Priority Data
Jul. 21, 2023 (KR) 10-2023-0095475

(51) Int. Cl. G01S 5/16

(52) U.S. Cl. CPC G01S 5/16

(57) ABSTRACT

A method and a device for estimating a position of a device by using an optical signal through converting a linearly polarized optical signal to a plurality of electric signals using a plurality of photoelectric devices, estimating a moving distance of the device from a reference position by using the plurality of electric signals, and estimating an orientation angle of the device with respect to a reference direction by using the plurality of electric signals are provided.

### CROSS-REFERENCE TO RELATED APPLICATIONS

This application claims priority under 35 U.S.C. § 119 to and the benefit of Korean Patent Application No. 10-2023-0095475 filed in the Korean Intellectual Property Office on Jul. 21, 2023, the entire contents of which are incorporated herein by reference.

### BACKGROUND

### 1. Field

The present inventive concepts relate to a method for positioning using an optical signal, and an apparatus using the same.

### 2. Related Art

Indoor position sensing technology may be used in home, industry, and commercial fields. Robots that make daily life convenient at home and devices for indoor mobility may use position sensing technology because they require accurate position information while moving to connect and control various devices inside a smart home.

In addition, indoor position sensing may be used in commercial fields to track customers and measure advertising effectiveness. For example, tracking a device and/or the user's movement path and behavior patterns may help establish and improve advertising and marketing strategies.

Further, it may be used for building security, such as tracking people's movement paths inside a building and monitoring the entry and exit of unauthorized people. Building security through indoor position sensing may help keep people safe at large events or public spaces.

Furthermore, indoor position sensing may be used to analyze game results and players' play styles by tracking players' positions and movement paths in indoor sports. Furthermore, indoor position sensing may be used in museums and other cultural attractions to provide visitors with information about exhibitions and guide them through the space.

### SUMMARY

Some embodiments provide an apparatus for estimating a position of a device.

Some embodiments provide a method for estimating a position of a device using an optical signal.

Some embodiments provide an optical communication system estimating a position of a device.

According to some embodiments, an apparatus for estimating a position of a device is provided. The apparatus may include: a plurality of photoelectric devices configured to sense light and convert the sensed light into electric signals; a lens assembly configured to focus the light such that an image of at least one source of the light is directed towards the plurality of photoelectric devices; and a controller configured to estimate a distance of the device from a reference position based on the electric signals received from the plurality of photoelectric devices.

According to some embodiments, a method for estimating a position of a device using an optical signal is provided. The method may include: converting the optical signal into a plurality of electric signals using a plurality of photoelectric devices included in the device; estimating a distance of the device from a reference position based on the plurality of electric signals; and estimating an orientation angle of the device with respect to a reference direction based on the plurality of electric signals.

According to some embodiments, an optical communication system estimating a position of a device is provided. The optical communication system may include: a transmitting device configured to generate a light signal by modulating data and transmitting a linearly polarized light signal by modulating a polarization state of the light signal; and a receiving device configured to receive the linearly polarized light signal, convert the received light signal into an electric signal using a plurality of photoelectric devices, and estimate a position of the device using the electric signal transmitted through a plurality of channels connected to the plurality of photoelectric devices.

### BRIEF DESCRIPTION OF THE DRAWINGS

FIG. 1 is a diagram illustrating a device moving indoors according to some embodiments.

FIG. 2 is a flowchart illustrating a method for estimating by a position estimation apparatus according to some embodiments.

FIG. 3A is a top view of the position estimation apparatus according to some embodiments.

FIG. 3B is a side view of the position estimation apparatus according to some embodiments.

FIG. 4A and FIG. 4B are diagrams illustrating movement of an image of a light source detected by the position estimation apparatus according to some embodiments.

FIG. 4C is a diagram illustrating movement of a device according to some embodiments.

FIG. 5A is a diagram illustrating a device detecting light of a light source according to some embodiments.

FIG. 5B is a diagram illustrating a position estimation apparatus according to some embodiments.

FIG. 6A is a diagram illustrating a device moving under a light source having with a rotating linear polarizer according to some embodiments.

FIG. 6B is a diagram illustrating a change in a polarization direction of the rotating linear polarizer according to some embodiments.

FIG. 6C is a diagram illustrating a response of a photoelectric device to light output from the rotating linear polarizer according to some embodiments.

FIG. 7A is a diagram illustrating an optical signal transmitted from a light source according to some embodiments.

FIG. 7B and FIG. 7C is a diagram illustrating a response of a photoelectric device to an optical signal output from a rotating linear polarizer according to some embodiments.

FIG. 8 is a flowchart illustrating a position estimation method of a position estimation apparatus according to some embodiments.

FIG. 9 is a cross-sectional view of a photoelectric device according to some embodiments.

FIG. 10 is a cross-sectional view of a photoelectric device according to some embodiments.

FIG. 11 is a diagram illustrating a pixel structure of an organic photoelectric device according to some embodiments.

FIG. 12 is a diagram illustrating a stacking structure of the organic photoelectric device according to some embodiments.

FIG. 13 is a block diagram illustrating an optical communication system according to some embodiments.

### DETAILED DESCRIPTION OF THE EMBODIMENTS

Hereinafter, with reference to the accompanying drawing, embodiments of the present disclosure will be described in detail and thus it can be easily implemented by a person of an ordinary skill in the technical field to which the present disclosure belongs. However, the present inventive concepts may be implemented in several different forms and are not limited to the embodiment described wherein. Like reference numerals designate like elements throughout the specification. It will be understood that when an element such as a layer, film, area, or substrate is referred to as being “on” another element, it may be directly on the other element or intervening elements may also be present. In contrast, when an element is referred to as being “directly on” another element, there may be no intervening elements present. In addition, in order to clearly describe the description in the drawing, parts irrelevant to the description will be omitted, and similar reference numerals are attached to similar parts throughout the specification.

In the entire specification, unless explicitly described to the contrary, the word “comprise”, and variations such as “comprises” or “comprising”, will be understood to imply the inclusion of stated elements but not the exclusion of any other elements.

In the present specification, expressions described in the singular may be construed in the singular or plural unless an explicit expression such as “one” or “single” is used. Additionally, in the present specification, “and/or” includes each of the constituent elements mentioned and any combination of one or more of them.

In the present specification, functional elements, including unit that has at least one function or operation such a “controller” and/or “processor”, may be implemented with processing circuitry including hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In the present specification, the terms including ordinal numbers such as first, second, etc. may be used to describe various elements, but the elements are not limited by the terms. The terms are used only for the purpose of distinguishing one element from another element. For example, without departing from the range of the technology disclosed in this specification, a first constituent element may be named a second constituent element, and similarly, a second constituent element may be named a first constituent element. Additionally, whenever a range of values is enumerated, the range includes all values within the range as if recorded explicitly clearly, and may further include the boundaries of the range. Accordingly, the range of “X” to “Y” includes all values between X and Y, including X and Y. Further, when the terms “about” or “substantially” are used in this specification in connection with a numerical value and/or geometric terms, it is intended that the associated numerical value includes a manufacturing tolerance (e.g., ±10%) around the stated numerical value. Further, regardless of whether numerical values and/or geometric terms are modified as “about” or “substantially,” it will be understood that these values should be construed as including a manufacturing or operational tolerance (e.g., ±10%) around the stated numerical values and/or geometry.

In the flowchart described with reference to the drawing, the order of operations may be changed, several operations may be merged, some operations may be divided, and specific operations may not be performed.

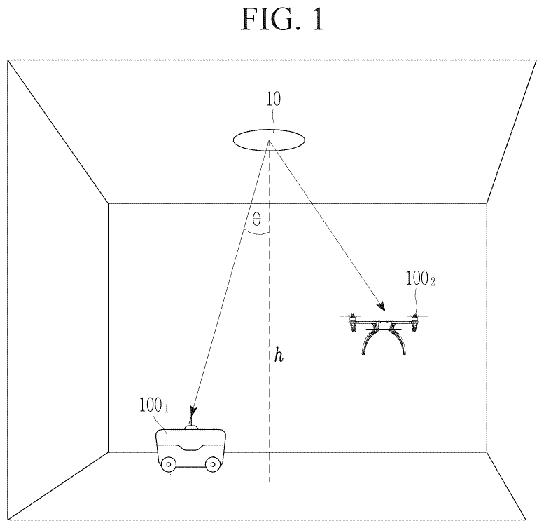

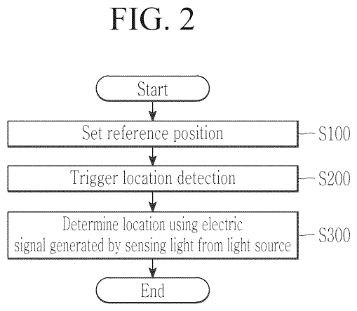

FIG. 1 is a diagram illustrating a device moving indoors according to some embodiments and FIG. 2 is a flowchart illustrating a method for estimating by a position estimation apparatus according to some embodiments.

In some embodiments, a device moving indoors may refer to a smart device. The smart device may include, for example, an autonomous robot, an indoor mobility device, an automatic flight device, and/or the like. The smart device according to some embodiments may be equipped with a position estimation apparatus. Therefore, the smart device such as automatic robots, indoor mobility devices, and automatic flight devices may acquire accurate position information determined by the position estimation apparatus.

Referring to FIG. 1, one or more devices, such as an automatic robot 1001 and/or an automatic flight device 1002, moving indoors may include the position estimation apparatuses and may perform position estimation by receiving light output from a light source 10.

The light output from the light source 10 may be an electromagnetic wave in a band and intensity that will not harm (e.g., is harmless to) the human body, such as visible ray, infrared, microwave, or radio waves. The position estimation apparatus may convert lights of at least one wavelength output from at least one light source 10 into electric signals and may accurately estimate an indoor position of the smart device by using the converted electric signals.

Referring to FIG. 2, the position estimation apparatus according to some embodiments may determine a reference position for starting position estimation of a smart device (S100). The reference position may be determined when the position estimation apparatus starts operating. For example, when the position estimation apparatus is powered on, the position estimation apparatus may set the reference position by storing the position and/or shape of the image of the light source 10 when the power of the position estimation apparatus is turned on.

After that, when the location detection is triggered (S200), the position estimation apparatus may determine the location of the smart device by estimating the position of the smart device by using the electric signals generated from detection of the light from the light source 10 (S300). For example, the position estimation apparatus may determine the change in the position and/or shape of the image of the light source 10 based on the electric signals generated by the light from the light source 10 and estimate a current position of the smart device based on the change of the position and/or shape of the image of the light source 10. The “current” point may be within a predetermined time interval from the point in time when the position estimation was triggered. In the following description, a method of estimating the position of the smart device using the electric signals generated based on the light received from the light source 10 by the position estimation apparatus will be described.

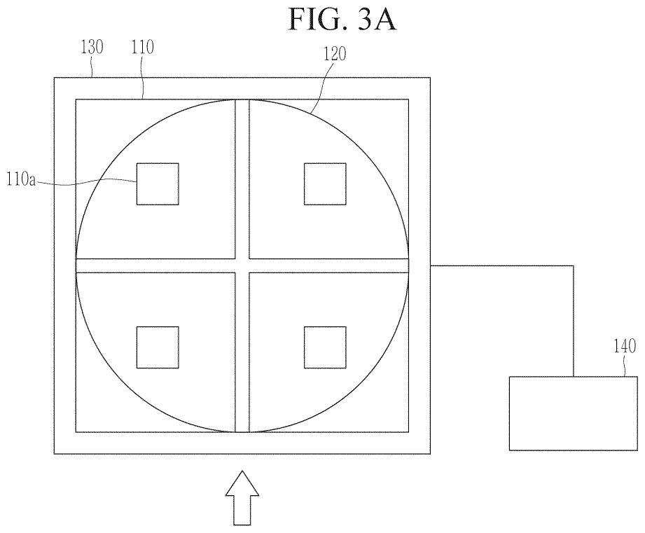

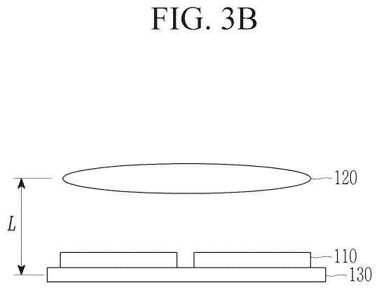

FIG. 3A is a top view of the position estimation apparatus according to some embodiments and FIG. 3B is a side view of the position estimation apparatus according to some embodiments.

Referring to FIG. 3A and FIG. 3B, a position estimation apparatus 100 according to some embodiments may include a plurality of photoelectric devices 110, a lens assembly 120, a substrate 130, and a controller 140. FIG. 3B is a side view of the position estimation apparatus 100 viewed from the arrow direction below in FIG. 3A. The controller 140 has been omitted from FIG. 3B for clarity.

The plurality of photoelectric devices 110 may be arranged on a light-receiving surface formed on the substrate 130. The light-receiving surface may be, for example, flat and/or curved. Each of the plurality of photoelectric devices 110 may be configured to detect light emitted from a light source 10 and to convert the detected light into an electric signal. In some embodiments, the plurality of photoelectric devices 110 may be arranged on a two-dimensional plane. For example, three photoelectric devices 110 may be arranged in a triangle, four photoelectric devices 110 may be arranged in a quadrangle (2×2 array), and/or the like.

Each of the plurality of photoelectric devices 110 may include an active zone 110a (alternatively, an active area) and the respective active zones may be configured to detect light and to generate an electric signal according to the intensity of the detected light. The electric signal generated in each active zone may be transmitted to the controller 140 through channels. On the substrate 130, the plurality of photoelectric device 110 may be arranged symmetrical to each other and/or the active zones 110a of the respective photoelectric devices 110 may be arranged symmetrical to each other.

In some embodiments, the plurality of photoelectric device 110 may form a single quadrant detector (QD). Each photoelectric device may be a photo diode (PD) and/or an organic PD (OPD). Details of the photoelectric device are detailed below.

The lens assembly 120 may focus light emitted from the light source 10 on the plurality of photoelectric devices 110. In some embodiments, the lens assembly 120 may be spaced apart from the photoelectric devices 110 based on a focal distance of the lens assembly 120. For example, the distance L between the lens assembly 120 and the photoelectric devices 110 may be focal distance of the lens assembly 120 or substantially equivalent to focal distance of the lens assembly 120. For example, L may denote a distance between the lens assembly 120 and the plurality of photoelectric devices 110 or a distance between the lens assembly 120 and an upper portion of the substrate 130. When the focal distance of the lens assembly 120 is L or substantially equivalent to L, the size of the image of light source 10 formed on the plurality of the photoelectric devices 110 is very small, and thus the light source 10 may be detected as a point light source by the plurality of photoelectric devices 110.

Additionally, in some embodiments, the lens assembly 120 may form an image of the light source 10 on the plurality of photoelectric devices 110 by focusing the light emitted from the light source 10. In this case, the focal distance of the lens assembly 120 may be greater than 0 and less than L. When the focus of the lens assembly 120 is formed between the lens assembly 120 and the plurality of photoelectric devices 110, an image having the same shape as that of the light source 10 may be formed on the plurality of photoelectric devices 110. For example, when the light source 10 is circular, a circular image that is smaller in size than the light source 10 may be formed on the plurality of photoelectric devices 110. When the light source 10 is a quadrangle, a quadrangle image that is smaller in size than the light source 10 may be formed on the plurality of photoelectric devices 110. When the light source 10 has a rod shape, a rod shape smaller in size than the light source 10 may be formed on the plurality of photoelectric devices 110.

The controller 140 may receive the electric signal through the channels connected with the plurality of photoelectric devices 110 and calculate a moving distance and direction of the image of the light source 10 by using the received electric signal such that a position of the smart device on which the plurality of photoelectric devices 110 is mounted may be estimated. In some embodiments, when four photoelectric devices are arranged on the substrate 130, the controller 140 of the position estimation apparatus 100 may receive four electric signals through four channels from four active zones 110a included in the respective photoelectric devices 110 and calculate a moving distance and direction of the image of the light source 10 by using the received electric signals. In at least one embodiment, the controller 140 may also estimate the speed and/or velocity based on a difference in moving direction during a time frame.

When the image of the light source 10 is formed in the plurality of photoelectric devices 110, the controller 140 may calculate a mass center of the image of the light source 10 and calculate a distance between the mass center of the image of the light source 10 and the reference position to thereby estimate a position of the smart device on which the plurality of photoelectric devices 110 or the position estimation apparatus 100 is mounted.

In some embodiments, a polarizer may be applied to the light source 10 and polarization filters having different polarization directions may be added on the plurality of photoelectric devices 110. As the polarization filters in different directions are combined with the plurality of photoelectric device 110, the intensity of the light from the light source 10 linearly polarized in one direction may be detected in different intensity by the plurality of photoelectric device 110. Based on this, an orientation angle of the position estimation apparatus 100 and/or an orientation angle of the smart device in which the position estimation apparatus 100 is installed may be calculated.

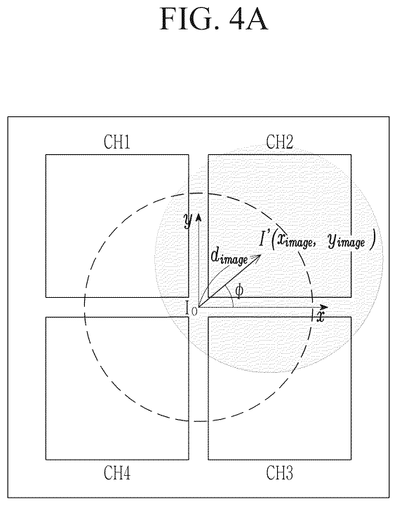

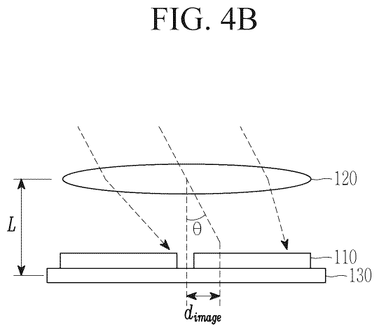

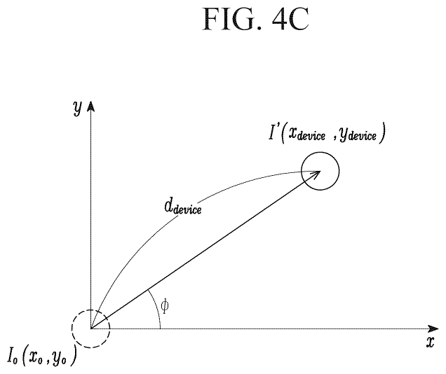

FIG. 4A and FIG. 4B are diagrams illustrating movement of an image of a light source detected by the position estimation apparatus according to some embodiments and FIG. 4C is a diagram illustrating movement of a device according to some embodiments.

Referring to FIG. 4A, an electric signal generated by a first photoelectric device among the plurality of photoelectric devices 110 may be transmitted to the controller 140 through a first channel CH1 connected to one of the photoelectric devices 110, an electric signal generated by a second photoelectric device among the plurality of photoelectric devices 110 may be transmitted to the controller 140 through a second channel CH2 connected to a second one of the photoelectric devices 110, an electric signal generated by a third photoelectric device among the plurality of photoelectric devices 110 may be transmitted to the controller 140 through a third controller CH3 connected to a third one of the photoelectric devices 110, and an electric signal generated by a fourth photoelectric device among the plurality of photoelectric devices 110 may be transmitted to the controller 140 through fourth channel CH4 connected to fourth one of the photoelectric devices 110. However, as noted above, the number of photoelectric devices 110 may be greater than or less than four, and therefore, the example embodiments are not limited to the four illustrated channels CH1-CH4.

Referring to FIG. 4A, when a smart device equipped with the position estimation apparatus 100 and/or the plurality of photoelectric devices 110 moves, an image of the light source 10 formed on the plurality of photoelectric device 110 may move from a reference position to I₀ to a new image position I′. When the coordinates of I′ are (x_{image}, y_{image}), a moving distance d_{image} of the light source 10 may be as shown in Equation 1 below.

$${d}_{image} = k \sqrt{{x}_{image}^{2} + {y}_{image}^{2}} \qquad ( Equation 1 )$$

In addition, an orthogonal coordinates x_{image} and y_{image} of the light source 10 may be as shown in Equation 2 below.

$$\begin{matrix}{x}_{image} = \frac{( {P}_{ch 2} + {P}_{c h 3} ) - ( {P}_{ch 1} + {P}_{c h 4} )}{{P}_{ch 1} + {P}_{ch 2} + {P}_{c h 3} + {P}_{ch 4}} \\ {y}_{image} = \frac{( {P}_{ch 1} + {P}_{ch 2} ) - ( {P}_{ch 3} + {P}_{c h 4} )}{{P}_{ch 1} + {P}_{ch 2} + {P}_{c h 3} + {P}_{ch 4}}\end{matrix} \qquad ( Equation 2 )$$

In Equation 2, P_{chn} (n=natural number) may indicate electric power or intensity of an optical signal transmitted through an n-th channel. In some embodiments, Pch1, Pch2, Pch3, and Pch4 may indicate power by the optical signals respectively transmitted through four channels connected with four photoelectric devices, respectively. In some embodiments, Equation 2 may be calculated by the intensities of the electric signals transmitted through each channel or the intensities of currents converted from the optical signals.

Referring to Equation 2, the x coordinate of the light source 10 may be determined based on a difference between optical electric powers of the channels Ch2 and Ch3 corresponding to the two photoelectric devices positioned in the +x direction and optical electric powers of the channels Ch1 and Ch4 corresponding to the two photoelectric devices positioned in the −x direction. In addition, the y coordinate of the light source 10 may be determined based on a difference between optical electric powers of the channels Ch1 and Ch2 corresponding to the two photoelectric devices positioned in the +y direction and optical electric powers of the channels Ch3 and Ch4 corresponding to the two photoelectric devices positioned in the −y direction.

Through the similarity relationship of the two right triangles shown in FIG. 1 and FIG. 4B, a relationship between a moving distance d_{image} of the image of the light source 10 and a moving distance d_{device} of the smart device equipped with the position estimation apparatus 100 or the plurality of photoelectric devices 110 may be established as shown in Equation 3 below.

$$h : L ≅ {d}_{d e v i c e} : {d}_{image} \qquad ( Equation 3 )$$

That is, the position estimation apparatus 100 may estimate an actual moving distance of the smart device by using a distance h (height h of the light source) from the floor of the room to the light source, a distance L between the lens assembly and the photoelectric devices, and a moving distance of the image of the light source.

In some embodiments, an indoor two-dimensional position of the smart device may be determined by d_{device} and ϕ. In other words, the polar coordinates (r, θ) of the smart device may be (d_{device}, ϕ). ϕ may be determined as given in Equation 4.

$$ϕ = arc tan ( \frac{{y}_{image}}{{x}_{image}} ) \qquad ( Equation 4 )$$

Alternatively, the position estimation apparatus 100 may calculate the orthogonal coordinates (x_{device}, y_{device}) of the smart device as in Equation 5 below.

$$\begin{matrix}{x}_{device} = {x}_{0} + {d}_{d e ν i c e} cos ( ϕ ) \\ {y}_{device} = {y}_{0} + {d}_{device} sin ( ϕ )\end{matrix} \qquad ( Equation 5 )$$

In Equation 5, x₀ and y₀ may be the coordinates of the reference position and may be used as the origin.

In some embodiments, the position estimation apparatus 100 may estimate a three-dimensional position of an automatic flight device 100₂ such as a drone and the like based on the change in the size or shape of the image of the light source. Alternatively, the position estimation apparatus 100 may estimate the height or three-dimensional position of the smart device by using optical signals from two or more additional light sources.

In some embodiments, the position estimation apparatus 100 may calculate a two-dimensional position of the automatic flight device 100₂ through Equation 1 to Equation 5 and compare the size or shape of the image of the light source at the reference position and the size or shape of the image of the light source at the moved position, thereby estimating the height of the automatic flight device 100₂.

For example, when the light source 10 is circular, the image of the light source 10 formed at the moved position may be elliptical. Accordingly, the position estimation apparatus 100 may estimate the height of the automatic flight device 100₂ based on a diameter of the light source 10 at the reference position, the height of the light source 10, and a diameter (and/or length of the minor/major axis) of the elliptical image of the light source 10 at the moved position. For example, in at least one embodiment, the position estimation apparatus 100 may estimate the position based on differences in position and shape between the reference image I₀ and the image and the moved position I′. Here, the two-dimensional position of the automatic flight device 100₂ may be used to accurately identify the diameter or minor/major axis of the image of the light source 10.

As described above, the indoor position of the smart device including the position estimation apparatus may be accurately estimated by calculating the moving distance of the image of the light source based on the height of the light source and a gap between modules inside the position estimation apparatus (e.g., the spacing between the lens assembly 120 and the photoelectric devices 110). In at least one embodiment, the indoor position of the smart device may be further collected, e.g., by a server or service, to track patterns in the user activity, and/or to help establish and improve advertising and marketing strategies.

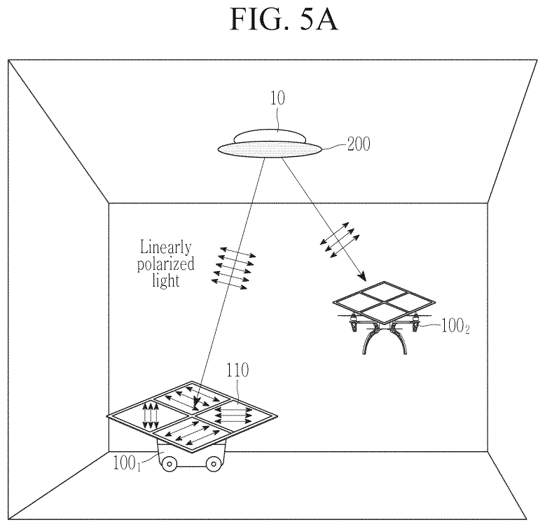

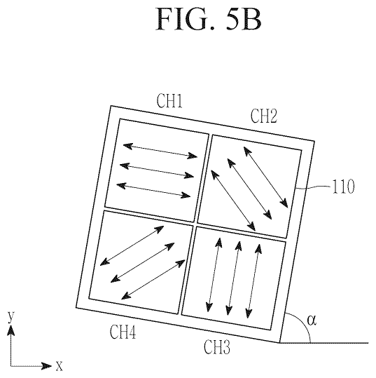

FIG. 5A is a diagram illustrating a device detecting light of a light source according to some embodiments and FIG. 5B is a diagram illustrating a position estimation apparatus according to some embodiments.

Referring to FIG. 5A, light originating from a light source 10 may reach a smart device after being polarized by a polarization filter or polarizer 200. In FIG. 5A, the polarizer 200 may convert the light from the light source 10 with a random polarization state to have one predetermined polarization state. For example, when the polarizer 200 is a linear polarizer, the light passing through the polarizer 200 may have a polarization state that oscillates in one direction that is determined by the polarizer 200.

In some embodiments, linearly polarized light may reach a plurality of photoelectric devices 110 to which polarization filters with different polarization directions are respectively applied. The linearly polarized light may be detected in different intensity in the plurality of photoelectric devices 110 by the polarization filters with different polarization directions. In other words, each of the plurality of photoelectric devices may generate electric signals of different intensities depending on an angle between the oscillation direction of the light and the polarization direction of the polarization filter.

In some embodiments, the controller 140 may calculate an orientation angle of the position estimation apparatus 100 and/or an orientation angle of the smart device equipped with the position estimation apparatus 100 based on the electric signals of different intensities received from each channel.

In some embodiments, each of the plurality of photoelectric devices may detect the intensity of the light in different intensity based on an angle between an oscillation direction of the linearly polarized light and a polarization direction of the polarization filter of each of the plurality of photoelectric devices. For example, when the light oscillates in a direction substantially equivalent to the polarization filter, an electric signal of the maximum intensity may be generated in the channel of the photoelectric device corresponding to the polarization filter. However, an electric signal smaller than that may be generated in a channel of another photoelectric device. In addition, an electric signal may be hardly generated in a channel of the photoelectric device corresponding to the polarization filter in a direction substantially orthogonal to the oscillation direction of the linearly polarized light.

Further, the controller 140 may compensate for decrease in the intensity of the electric signal received from each channel based on information about the polarization direction of each polarization filter and more accurately estimate the position of the smart device by using the intensity of the compensated electric signal. That is, the controller 140 may estimate the position and orientation angle of the smart device by distinguishing a decrease in signal intensity due to movement of the smart device and a decrease in signal intensity due to a change in the orientation angle of the smart device.

For example, the controller 140 may estimate an oscillation direction of the linearly polarized light of the light source based on information of the intensity of the electric signal from the plurality of photoelectric devices 110 and the polarization direction of the polarization filter of the plurality of photoelectric device, and may compensate for the intensity of the electric signal from the plurality of photoelectric devices 110 based on the estimated oscillation direction of the linearly polarized light. That is, the controller 140 may compensate for the decrease in the intensity of the electric signal caused by the difference between the oscillation direction of the linearly polarized light and the polarization direction of the polarization filter, and accurately estimate the position of the smart device based on the intensity-compensated electric signal. Referring to FIG. 5B, the polarization directions of the polarization filters may include at least one of a horizontal direction, a vertical direction, a diagonal direction, and an antidiagonal direction. Alternatively, the polarization angles of the polarization filter corresponding to four polarization devices may be, for example, 0°, 45°, 90°, and 135°. In some embodiments, the horizontal, vertical, diagonal, and opposite angle direction may each represent relative directions, and each of 0°, 45°, 90°, and 135° may correspond to relative angles.

For example, among the plurality of photoelectric devices, a first photoelectric device may include a polarization filter with a horizontal direction or 0°, a second photoelectric device may include a polarization filter with a diagonal direction or 45°, a third photoelectric device may include a polarization filter with a vertical direction or 90°, and a fourth photoelectric device may include a polarization filter with an antidiagonal direction or 135°.

When light oscillating in a specific direction is incident on such photoelectric devices, the position estimation apparatus 100 may calculate an orientation angle of the position estimation apparatus 100 (or a smart device equipped with the position estimation apparatus 100) by using an electric signal received from a channel corresponding to each of the plurality of photoelectric devices. The orientation angle of the position estimation apparatus 100 may be an angle with respect to a reference direction or an x-axis that is virtually predetermined in an indoor space. Here, the reference direction may be pre-determined when the reference position of the position estimation apparatus 100 is determined.

The intensity of a current generated in the channel of each photoelectric device may be calculated using parameter values of the photoelectric device based on the relationship between the filter applied to each photoelectric device and the incident polarized light. Equation 6 below may represent the intensity In of the current generated in an n-th channel connected to an n-th photoelectric device when the linearly polarized light reaches the plurality of photoelectric devices.

$${I}_{n} = 0.5 RP + 0.5 RPD \cdot cos ( 2 α - 2 {φ}_{n} ) \qquad ( Equation 6 )$$

In Equation 6, R may denote reactivity (0≤R≤1) of the plurality of photoelectric devices with respect to light, P may denote electric power of light incident on the plurality of photoelectric devices, and D may denote polarization diattenuation (0≤D≤1). In addition, α may denote an orientation angle of a substrate on which the plurality of photoelectric devices 110 are arranged. The orientation angle of the substrate on which the plurality of photoelectric devices 110 are arranged may correspond to a rotation angle of the smart device on which the position estimation apparatus 100 is mounted.

In Equation 6, φₙ may denote a polarization angle of a polarization filter applied to a photoelectric device corresponding to an n-th channel. The polarization angle of the polarization filter may be determined depending on the number n of polarization devices. For example, when there are n polarization devices, the polarization angles of each of the plurality of polarization filters may differ by π/n°. Referring to FIG. 5B, the polarization angles of the polarization filter corresponding to the four polarization devices may be 0°, 45°, 90°, and 135°, respectively. Equation 6 may be expanded as Equation 7 below.

$${I}_{n} = 0.5 RP + 0.5 RPD \cdot cos ( 2 α ) cos ( - 2 {φ}_{n} ) - 0.5 RPD \cdot sin ( 2 α ) sin ( - 2 {φ}_{n} ) \qquad ( Equation 7 )$$

In the embodiment, when the position estimation apparatus 100 includes four channels, the intensity of the current that flows through each channel may be equal to Equation 8 below.

$$[ \begin{matrix}{I}_{1} \\ {I}_{2} \\ {I}_{3} \\ {I}_{4}\end{matrix} ] = [ \begin{matrix}1 & cos ( 2 {φ}_{1} ) & sin ( 2 {φ}_{1} ) \\ 1 & cos ( 2 {φ}_{2} ) & sin ( 2 {φ}_{2} ) \\ 1 & cos ( 2 {φ}_{3} ) & sin ( 2 {φ}_{3} ) \\ 1 & cos ( 2 {φ}_{4} ) & sin ( 2 {φ}_{4} )\end{matrix} ] [ \begin{matrix}0.5 RP \\ 0.5 RPD \cdot cos ( 2 α ) \\ 0.5 RPD \cdot sin ( 2 α )\end{matrix} ] \qquad ( Equation 8 )$$

The left term on the right side of Equation 8 can be transferred to the left side, and Equation 8 can be organized around the right term on the right side to get Equation 9 below.

$$[ \begin{matrix}0.5 RP \\ 0.5 RPD \cdot cos ( 2 α ) \\ 0.5 RPD \cdot sin ( 2 α )\end{matrix} ] = {( [ \begin{matrix}1 & 1 & 1 & 1 \\ cos ( 2 {φ}_{1} ) & cos ( 2 {φ}_{2} ) & cos ( 2 {φ}_{3} ) & cos ( 2 {φ}_{4} ) \\ sin ( 2 {φ}_{1} ) & sin ( 2 {φ}_{2} ) & sin ( 2 {φ}_{3} ) & sin ( 2 {φ}_{4} )\end{matrix} ] [ \begin{matrix}1 & cos ( 2 {φ}_{1} ) & sin ( 2 {φ}_{1} ) \\ 1 & cos ( 2 {φ}_{2} ) & sin ( 2 {φ}_{2} ) \\ 1 & cos ( 2 {φ}_{3} ) & sin ( 2 {φ}_{3} ) \\ 1 & cos ( 2 {φ}_{4} ) & sin ( 2 {φ}_{4} )\end{matrix} ] )}^{- 1} [ \begin{matrix}1 & 1 & 1 & 1 \\ cos ( 2 {φ}_{1} ) & cos ( 2 {φ}_{2} ) & cos ( 2 {φ}_{3} ) & cos ( 2 {φ}_{4} ) \\ sin ( 2 {φ}_{1} ) & sin ( 2 {φ}_{2} ) & sin ( 2 {φ}_{3} ) & sin ( 2 {φ}_{4} )\end{matrix} ] [ \begin{matrix}{I}_{1} \\ {I}_{2} \\ {I}_{3} \\ {I}_{4}\end{matrix} ] \qquad ( Equation 9 )$$

In Equation 9, the term on the right side includes matrix multiplication of the matrix regarding the polarization directions of the polarization filters corresponding to each of the plurality of photoelectric devices and the matrix of the intensity of the current measured in the channel. The position estimation apparatus 100 may determine the orientation angle α of the substrate on which the plurality of photoelectric devices are arranged (Equation 11) from the result of the operation (matrix A in Equation 10) between the matrix regarding the polarization directions of the polarization filters and the intensity matrix of the measured current.

$$[ \begin{matrix}0.5 RP \\ 0.5 RPD \cdot cos ( 2 θ ) \\ 0.5 RPD \cdot sin ( 2 θ )\end{matrix} ] = [ \begin{matrix}{A}_{1} \\ {A}_{2} \\ {A}_{3}\end{matrix} ] = A \qquad ( Equation 10 )$$

$$\frac{0.5 RPD \cdot sin ( 2 θ )}{0.5 RPD \cdot cos ( 2 θ )} = tan 2 θ = \frac{{A}_{3}}{{A}_{2}} \qquad ( Equation 11 )$$

As described above, the position estimation apparatus 100 may determine an orientation angle with respect to the reference direction of the position estimation apparatus 100 or the smart device based on the intensity of the current generated by the linearly polarized light from the light source reaching each photoelectric device having different polarization properties and information about the polarization directions of the polarization filters corresponding to each photoelectric device.

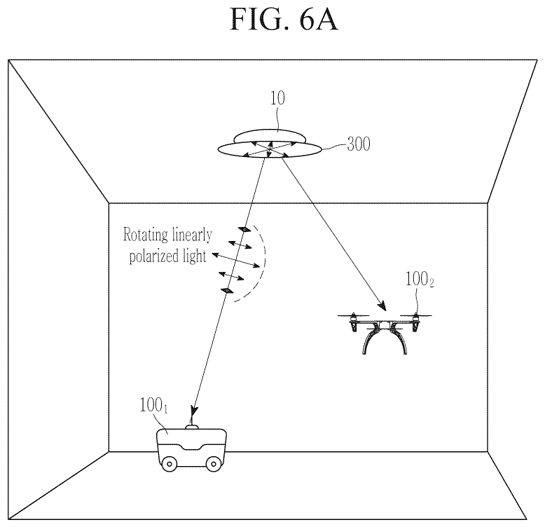

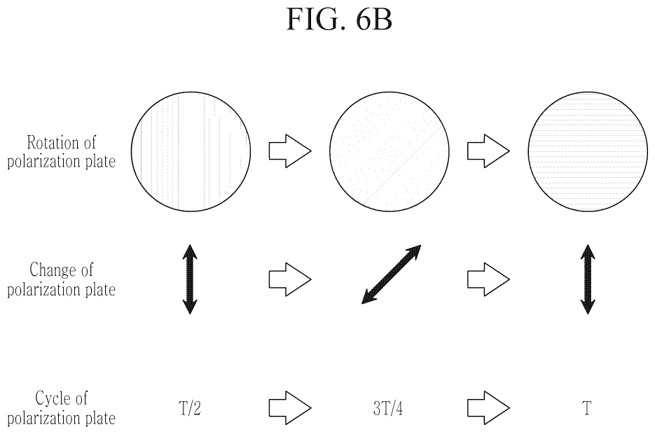

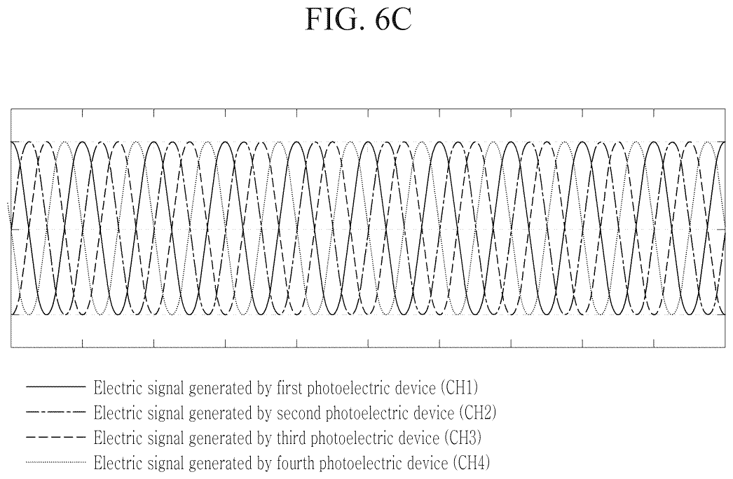

FIG. 6A is a diagram illustrating a device moving under a light source having with a rotating linear polarizer according to some embodiments, FIG. 6B is a diagram illustrating a change in a polarization direction of the rotating linear polarizer according to some embodiments, and FIG. 6C is a diagram illustrating a response of a photoelectric device to light output from the rotating linear polarizer according to some embodiments.

Referring to FIG. 6A, light (e.g., continuous wave CW) started from a light source 10 may pass through a rotating linear polarizer 300 and reach a smart device. In some embodiments, the rotating linear polarizer 300 may rotate between the light source 10 and the smart device and linearly polarize the light in different polarization direction at every moment. The rotation speed or rotation cycle of the rotating linear polarizer 300 may be determined in advance.

In some embodiments, the rotation cycle of the rotating linear polarizer 300 may be determined based on a bit rate of data modulated at the light source 10. For example, when the bit rate of data transmitted from the light source 10 is 1 kbps, a rotation cycle T of the rotating linear polarizer 300 may be shorter than 1 millisecond (ms) (T=1/1000) (0.5 ms, 0.2 ms, and the like).

Referring to FIG. 6B, the polarization direction of the linearly polarized light may change periodically and continuously depending on the rotation of the rotating linear polarizer 300. In FIG. 6B, the polarization direction of rotating linear polarizer 300 changes from vertical to horizontal, and each change moment of polarization direction is shown in FIG. 6B. For example, the vertical direction may correspond to the polarizer 300 at the moment of T/2, and the horizontal direction may correspond to the polarizer 300 at the moment of T. Referring to FIG. 6C, responses of four photoelectric devices receiving the polarization-modulated light by the rotating linear polarizer 300 are shown. For example, the electric signal of CH2 generated by the second photoelectric device may be delayed by T/4 compared to the electric signal of CH1 generated by the first photoelectric device. Therefore, the delay between the respective electric signals may correspond to a difference of the polarization direction between the respective polarization filters.

In some embodiments, when there is a plurality of light sources 10 in an indoor space and a rotating linear polarizer 300 with different rotation cycles is applied to each of the plurality of light source 10, each of the position estimation apparatus 100 for different smart devices may identify the different light source 10 based on a response waveform of the light signal. That is, when the plurality of light sources 10 exist in a relatively large space, the position estimation apparatus 100 may implement frequency division multiplexing (FDM) based on the light signals received from the plurality of light sources 10.

Furthermore, the accuracy of the estimation of the position and orientation angle can be improved even in radio frequency (RF) sensitive areas and ambient light interference areas by using the optical signal linearly polarized by the rotating linear polarizer, and the cost and complexity of the estimation of the position and orientation angle can be reduced. In addition, information necessary for the estimation of the position can obtained dynamically and the memory required for storing the information necessary for the position estimation can be saved by receiving information about the light source from the transmitting device connected to the light source.

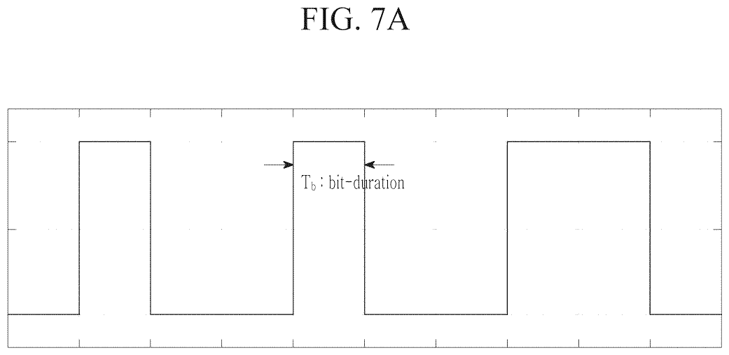

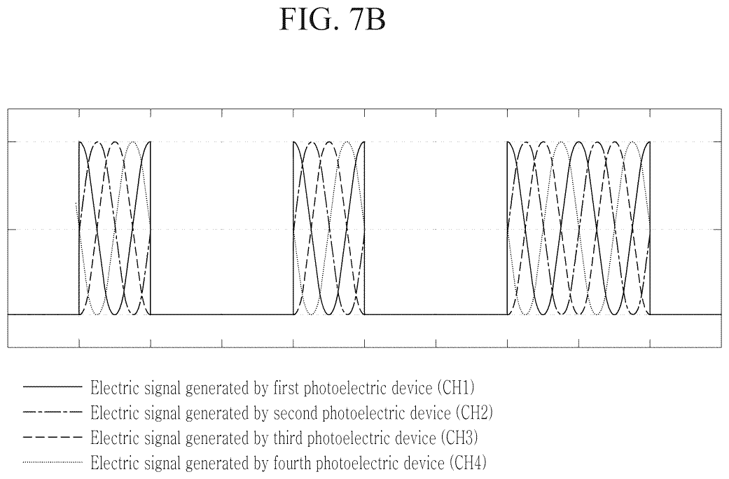

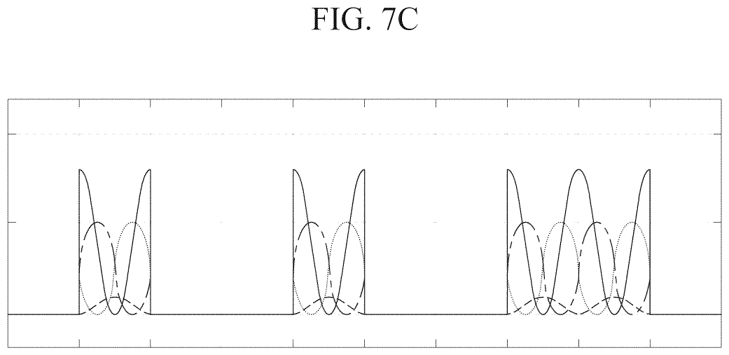

FIG. 7A is a diagram illustrating an optical signal transmitted from a light source according to some embodiments and FIG. 7B and FIG. 7C is a diagram illustrating a response of a photoelectric device to an optical signal output from a rotating linear polarizer according to some embodiments.

In some embodiments, a transmitting device (not shown) may modulate pre-determined data into an optical signal and transmit the modulated optical signal through a light source 10. The transmitting device may transmit information including at least one of a position of the light source 10 (a height from the floor of the room to the light source, a two-dimensional position of the light source, and the like), an identifier of the light source 10, and an indoor space (area and the like) as the data through the optical signal. That is, the position estimation apparatus 100 may dynamically obtain the information related to the estimation of the position of a smart device receiving the optical signal and save the information on a memory by receiving the information about the light source (position of the light source, identifier of the light source, and the like) from the transmitting device connected to the light source. In at least one embodiment, the information may be transmitted at a frequency not detectable by human eyes.

Referring to FIG. 7A, the optical signal transmitted from the light source 10 may have a bit duration of Tb. After that, a polarization state of the optical signal transmitted from the light source 10 by CW pulses may be modulated by the rotating linear polarizer 300 and the polarization-modulated optical signal may be converted into an electric signal by a plurality of photoelectric devices 110 which receives the polarization-modulated optical signal (refer to FIG. 7B).

As described previously, Tb of the optical signal may be an integer multiple of the rotation cycle of the rotating linear polarizer 300. In FIG. 7B and FIG. 7C, T_{b} of the optical signal is equal to the rotation cycle of the rotating linear polarizer 300. FIG. 7B may show a response of the photoelectric devices when the lens assembly 120 is not provided, and FIG. 7C may show a response of the photoelectric devices when the lens assembly 120 is provided. That is, the image of the light source 10 by the lens assembly 120 is formed on at least one part of photoelectric devices, and thus a maximum value of the response (electric signal) from the channels connected to the photoelectric devices may be different.

In some embodiments, when the smart device moves, an average value or maximum value (peak value) of the electric signal generated by the optical signal passing through the lens assembly 120 may be different for each photoelectric device. Referring to FIG. 7C, the intensity of the electric signal transmitted through CH1 is the greatest, and the intensity of the electric signal transmitted through CH3 is the smallest. This may mean that the image of the light source has moved toward the first photoelectric device of CH1 and thus the position estimation apparatus 100 may estimate a current position of the smart device based on Equations 1 to 5 based on that the image of the light source has moved toward the first photoelectric device.

The position estimation apparatus 100 may demodulate data from the transmitting device by using an electric signal such as FIG. 7C, estimate a moving distance of the smart device (e.g., a receiving device), and estimate an orientation angle of the smart device.

The position estimation apparatus 100 may be used to demodulate data by summing the electric signals transmitted from the respective channels. In addition, the position estimation apparatus 100 may estimate the moving distance of the smart device by averaging the electric signal transmitted from each channel or using the maximum value of the electric signal. Further, the position estimation apparatus 100 may estimate the orientation angle of the smart device by scaling the electric signal transmitted from each channel.

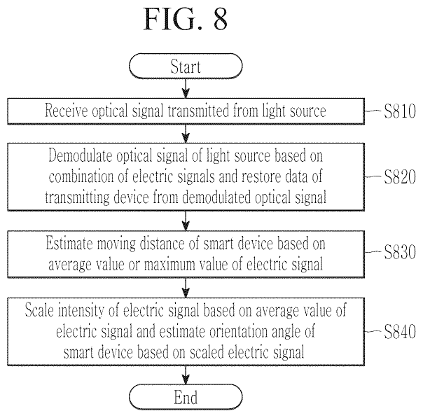

FIG. 8 is a flowchart illustrating a position estimation method of a position estimation apparatus according to some embodiments.

In some embodiments, a position estimation apparatus 100 may estimate a position by using an electric signal converted from an optical signal passing through a rotating linear polarizer 300, estimate an orientation angle of a smart device, and recover data corresponding to the optical signal. The data that the transmitting device transmits through the optical signal transmitted by light source 10 may include information about at least one of a position of a light source 10 (height from the floor of the room to the light source, the two-dimensional position of the light source, and the like), an identifier of the light source, and an indoor space (area, and the like).

Referring to FIG. 8, the position estimation apparatus 100 according to some embodiments may receive the optical signal transmitted from the light source 10 (S810). In at least some embodiments, the optical signal may contain data transmitted through the light source 10 and/or may be polarization-modulated by a rotating linear polarizer 300 before reaching the position estimation apparatus 100 or the smart device.

The position estimation apparatus 100 may demodulate the optical signal of the light source 10 based on a sum of electric signals transmitted from channels connected to a plurality of photoelectric devices which receive the optical signal and recover the data of the transmitting device from the demodulated optical signal (S820).

In addition, the position estimation apparatus 100 according to some embodiments may estimate a moving distance of the smart device in which the position estimation apparatus 100 mounted based on an average value or maximum value of the electric signals transmitted from the respective channels connected to the plurality of photoelectric devices (S830). The data recovered from the previous step may be used to estimate the moving distance of the smart device.

In some embodiments, when minimum values (or 0 level, DC level) of each of the electric signals received from the channels are not substantially equivalent, it may be determined that there is an influence from another light source. Therefore, the position estimation apparatus 100 may determine the moving distance of the smart device based on the maximum values of the electric signals from the channels when a difference between the minimum values of the electric signals of the respective channels is relatively large (larger than a pre-determined threshold value). However, the position estimation apparatus 100 may determine the moving distance of the smart device based on an average value of the electric signals of each of the channels when a difference between the minimum values of the electric signals of the respective channels is relatively small (smaller than the pre-determined threshold value) (refer to Equation 2).

In addition, the position estimation apparatus 100 may scale intensity of the electric signal of each channel based on the average value of the electric signals transmitted from the channels connected to the plurality of photoelectric devices and estimate an orientation angle of the smart device based on the scaled electric signal (S840). The data recovered from the previous step may be used to estimate the orientation angle of the smart device.

As described above, the position estimation apparatus according to some embodiments may use optical signals linearly polarized by a rotating linear polarizer to increase the accuracy of the estimation of the position and orientation angle even in RF-sensitive areas or when there is ambient light interference and to reduce cost and complexity of the estimation of the position and orientation angle.

In addition, the response of the photoelectric devices to the linear polarizer rotating at a pre-determined cycle may be obtained by using a maximum value (peak value) of the electric signals, an average of the peak value of the electric signals, standard deviation of the electric signals, or frequency filtering for the electric signals, and thereby implementing an optical communication system that is highly robust to the interference light.

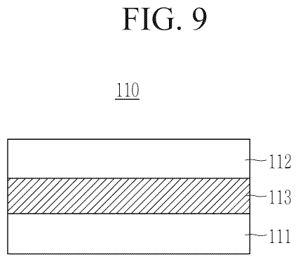

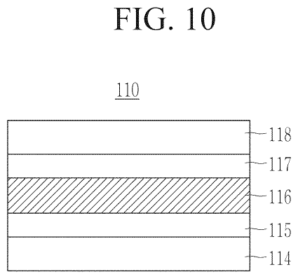

Further, since the data may be modulated into an optical signal by using a rotating linear polarizer and the optical signal may be converted into an electric signal at a relatively fast response by the plurality of photoelectric devices, so that the optical signal from the light source containing the data may be received by the plurality of photoelectric devices without an additional data receiver. When the plurality of photoelectric devices are implemented with organic optical diodes (OPDs), data communication and position estimation can be provided simultaneously by applying them to wearable devices and/or the like through the printerability and flexibility of the OPDs. FIG. 9 is a cross-sectional view of a photoelectric device according to some embodiments and FIG. 10 is a cross-sectional view of a photoelectric device according to some embodiments.

In FIG. 9 and FIG. 10, thickness of each layer and area is enlarged to clearly express multiple layers and areas.

A photoelectric device 110 according to some embodiments may be an organic photoelectric device. Referring to FIG. 9, an organic photoelectric device may include a first electrode 111 and a second electrode 112 that face each other, and an active layer 113 disposed between the first electrode 111 and the second electrode 112.

One of the first electrode 111 and the second electrode 112 may be an anode, and the other may be a cathode. At least one of the first electrode 111 and the second electrode 112 may be a light-transmitting electrode (e.g., transparent to a predetermined wavelength). The light-transmitting electrode may be formed of, for example, a transparent conductor such as indium tin oxide (ITO) or indium zinc oxide (IZO), and may be a thin single-layer or multi-layer metal thin film. Additionally, one of the first electrode 111 and the second electrode 112 may be a non-light-transmitting electrode, such that the electrode may be formed of an opaque conductor such as aluminum (Al).

For example, the first electrode 111 and the second electrode 112 both may be light-transmitting electrodes or the first electrode 111 and the second electrode 112 may be a light-transmitting electrode and the other an opaque electrode.

The active layer 113 may include a P-type semiconductor and an N-type semiconductor, and a PN junction may be formed in the active layer 113. The PN junction may be a bulk heterojunction containing a mixture of a P-type material (P-type semiconductor) and an N-type material (N-type semiconductor) or a planar heterojunction in which the P-type material and the N-type material are stacked, respectively. In the active layer 113, light transmitted from the outside of the organic photoelectric device may generate excitons within the active layer 113 and the generated excitons may be separated into holes and electrons in the active layer 113.

The active layer 113 may include a first compound as the P-type semiconductor or the N-type semiconductor.

The first compound may be a light absorber that selectively absorbs light in the predetermined wavelength band. For example, the first compound may selectively absorb light in a green wavelength band. For example, a maximum absorption wavelength λmax of the first compound may be between about 500 (nanometers) nm to about 600 nm and may have an energy bandgap of about 2.0 electron volts (eV) to 2.5 eV.

Referring to FIG. 10, an organic photoelectric device according to some embodiments may include a first electrode 114 and a second electrode 118 that face each other, and an active layer 116 disposed between the first electrode 114 and the second electrode 118.

In addition, the organic photoelectric device according to some embodiments may further include charge auxiliary layers 115 and 117 between the first electrode 114 and the active layer 116 and between the second electrode 118 and the active layer 116, respectively. The charge auxiliary layers 115 and 117 may increase efficiency by facilitating the movement of holes and electrons separated in the active layer 116.

The charge auxiliary layers 115 and 117 may include at least one selected from a hole injecting layer (HIL) that facilitates the injection of holes, a hole transporting layer (HTL) that facilitates the transport of holes, an electron blocking layer (EBL) that blocks the movement of electrons, an electron injecting layer (EIL) that facilitate the injection of electrons, an electron transporting layer (ETL) that facilitate the transport of electrons, and a hole blocking layer (HBL) that blocks the movement of holes.

The charge auxiliary layers 115 and 117 may include, for example, an organic material, an inorganic material, or an organic-inorganic material. The organic material may be an organic compound with a related hole or electron characteristic, and the inorganic material may be a metal oxide such as molybdenum oxide, tungsten oxide, or nickel oxide.

The hole transport layer (HTL) may include, for example, at least one selected from PEDOT:PSS(poly(3,4-ethylenedioxythiophene):poly(styrenesulfonate)), polyan arylamine, poly(N-vinylcarbazole), polyaniline, polypyrrole, N,N,N′,N′-tetrakis(4-methoxyphenyl)-benzidine (MeQ-TPD), 4-bis[N-(1-naphthyl)-N-phenyl-amino]biphenyl (α-NPD), m-MTDATA, 4,4′,4″-tris(N-carbazolyl)-triphenylamine (TCTA), and a combination thereof, but is not limited thereto.

The electron blocking layer (EBL) may include, for example, at least one selected from poly(3,4-ethylenedioxythiophene):poly(styrenesulfonate) (PEDOT:PSS), polyan arylamine, poly(N-vinylcarbazole), polyaniline, polypyrrole, N,N,N′,N′-tetrakis(4-methoxyphenyl)-benzidine (TPD), 4-bis [N-(1-naphthyl)-N-phenyl-amino]biphenyl (α-NPD), m-MTDATA, 4,4′,4″-tris(N-carbazolyl)-triphenylamine (TCTA), and a combination thereof, but is not limited thereto.

The electron transport layer (ETL) may include, for example, at least one selected from 1,4,5,8-naphthalene-tetracarboxylic dianhydride (NTCDA), bathocuproine (BCP), LiF, Alq3, Gaq3, Inq3, Znq2, Zn(BTZ)2, BeBq2 and a combination thereof, but is not limited thereto.

The hole blocking layer (HBL) may include, for example, at least one selected from 1,4,5,8-naphthalene-tetracarboxylic dianhydride (NTCDA), bathocuproine (BCP). LiF, Alq3, Gaq3, Inq3, Znq2, Zn(BTZ)2, BeBq2, and a combination thereof, but is not limited thereto.

In at least some embodiments, one of charge auxiliary layers 115 and 117 may be omitted.

The organic photoelectric device may be applied to a solar cell, an image sensor, an optical detector, an optical sensor, and an organic photo diode (OPD), but is not limited thereto.

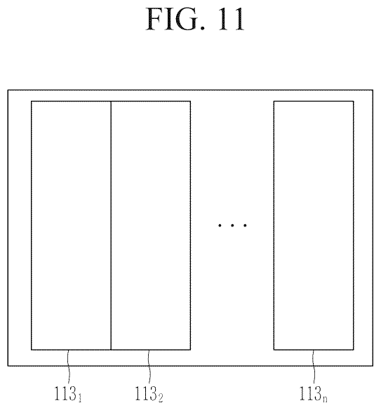

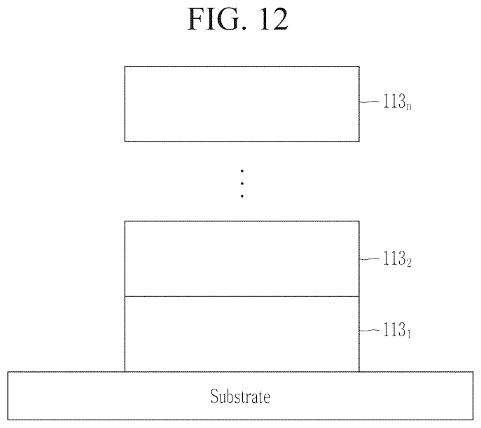

FIG. 11 is a diagram illustrating a pixel structure of an organic photoelectric device according to some embodiments and FIG. 12 is a diagram illustrating a stacking structure of the organic photoelectric device according to some embodiments.

An organic photoelectric device shown in FIG. 11 and FIG. 12 may sequentially or simultaneously convert optical signals having different wavelength bands to electric signals. When an optical signal in a first wavelength band and an optical signal in a second wavelength band are sequentially received by the organic photoelectric device, the organic photoelectric device may generate the electric signals according to each of the optical signals through cells or active layers corresponding to each wavelength band. Alternatively, when the optical signal in the first wavelength band and the optical signal in the second wavelength band simultaneously reach the organic photoelectric device, the organic photoelectric device may generate the electric signals according to each of the optical signals through the cell or active layer corresponding to each wavelength band. That is, the photoelectric conversion ability of the organic photoelectric device may be determined according to the wavelength band corresponding to the cell or active layer included in the organic photoelectric device.

Referring to FIG. 11, the organic photoelectric device according to an embodiment may include a plurality of cells pixelated on the substrate. Each cell in the organic photoelectric device may include a plurality of active layers 113₁ to 113ₙ arranged in a two-dimensional arrangement structure, and each of the plurality of active layers 113₁ to 113ₙ may correspond to a different wavelength band.

The plurality of cells included in the organic photoelectric device may be pixelated on a plane, and the plurality of active layers 113₁ to 113ₙ of each cell may respectively correspond to the plurality of wavelength bands. For example, among the active layers in the cell, a first active layer 113₁ corresponds to a near infrared band, a second active layer 113₂ corresponds to a red light band, a third active layer 113₃ corresponds to a green light band, a fourth active layer 113₄ corresponds to a blue light band, and a fifth active layer 113₅ corresponds to a near ultraviolet (UV) band. Each cell may include all of the first to fifth active layers, or, if necessary, may include some active layers among the first to fifth active layers.

For example, when each cell of the organic photoelectric device includes the second active layer 113₂, the third active layer 113₃, and the fourth active layer 113₄, the organic photoelectric device may convert all optical signals in the visible band into electric signals. Alternatively, when each cell of the organic photoelectric device includes the first active layer 113₁ and the third active layer 113₃, the organic photoelectric device may convert an optical signal in the infrared band and an optical signal in the green light band to electric signals.

FIG. 12 shows a stacking structure of one cell of the organic photoelectric device according to some embodiments.

Each of cells stacked in the organic photoelectric device according to some embodiments may include a plurality of active layers 113₁ to 113ₙ having a three-dimensional stacking structure, and the plurality of active layers 113₁ to 113ₙ may correspond to different wavelength bands.

Referring to FIG. 12, a first active layer 113₁ stacked on a substrate may convert an optical signal in a red light band to an electric signal, a second active layer 113₂ stacked on the first active layer 113₁ may convert an optical signal in a green light band to an electric signal, and a third active layer 113₃ stacked on the second active layer 113₂ may convert an optical signal in a blue light band to an electric signal. Here, the stacked active layers may be separated from each other by a transparent separation layer between them.

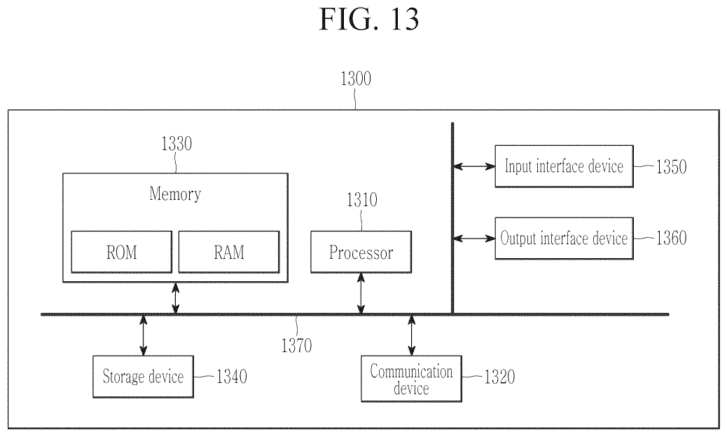

FIG. 13 is a block diagram of an optical communication system according to an embodiment.

Parts of a transmitting device and a receiving device of an optical communication system according to some embodiments may be implemented as a computer system, for example, a computer-readable medium. Referring to FIG. 13, a computer system 1300 of the transmitting device or receiving device may include at least one of a processor 1310 communicating through a bus 1370, a memory 1330, an input interface device 1350, an output interface device 1360, and a storage device 1340. The computer system 1300 may also include a communication device 1320 coupled to a network. The processor 1310 may be a central processing unit (CPU), or a device that executes instructions stored in the memory 1330 and/or storage device 1340.

The memory 1330 and the storage device 1340 may include various types of volatile or non-volatile storage media. For example, the memory may include a read only memory (ROM) and/or a random access memory (RAM). In some embodiments, the memory 1330 may be disposed inside or outside the processor, and the memory may be connected to the processor through various known means. The memory is volatile or non-volatile storage medium of various forms, and for example, the memory may include a read-only memory (ROM) or a random access memory (RAM).

Accordingly, aspects of the embodiments may be implemented as a method implemented in a computer, and/or as a non-transitory computer-readable medium in which the computer-executable instructions are stored. In the embodiment, computer readable instructions, when executed by a processor, may perform a method according to at least one aspect of the present inventive concepts.

The communication device 1320 may transmit and/or receive a wireless signal or a wireless signal.

The input interface device 1350 and output interface device 1360 may communicate with a user. For example, the input interface device 1350 and/or output interface device 1360 may include a digital screen, touch pad, keypad, haptic device, etc. configured to receive information from a user and/or to communicate information to a user.

Meanwhile, the embodiment is not only implemented through the device and/or method described so far, but may also be implemented through a program that realizes the function corresponding to the configuration of the embodiment or a recording medium on which the program is recorded, and such implementation can be easily implemented by a person skilled in the art of the present disclosure from the disclosure of the detailed embodiment. Specifically, the method according to the embodiment (e.g., network management method, data transmission method, transmission schedule produce method, and the like) is implemented in the form of a program instruction that can be executed through various computer means and can be recorded on a computer-readable medium. The computer-readable medium may include program instructions, data files, data structures, and the like singly or in combination. Program instructions recorded on a computer-readable medium may be specially designed and configured, for examples, or may be known and usable by those skilled in the art of computer software. A computer-readable recording medium may include a hardware device configured to store and execute program instructions. For example, the computer-readable recording medium includes a magnetic medium such as a hard disk, a floppy disk, and a magnetic tape, an optical medium such as a CD-ROM, a DVD, and a magneto-optical media such as a floptical disk, a ROM, a RAM, and a flash memory, and the like. A program instruction may include not only a machine language code such as that created by a compiler, but also a high-level language code that can be executed by a computer through an interpreter, and the like.

Although the embodiment has been described in detail above, the scope is not limited to this, and various modifications and improvements of a person of an ordinary skill in the art using the basic concept defined in the following claim range also fall within the scope.

What is claimed is:

1. An apparatus for estimating a position of a device, the apparatus comprising:
a plurality of photoelectric devices configured to sense light and convert the sensed light into electric signals;
a lens assembly configured to focus the light such that an image of at least one source of the light is directed towards the plurality of photoelectric devices; and
a controller configured to estimate a distance of the device from a reference position based on the electric signals received from the plurality of photoelectric devices.

2. The apparatus of claim 1, wherein
the plurality of photoelectric devices are arranged on a two-dimensional plane such that an intensity of the electrical signals vary based on a relative position of the at least one source of the light, and
the controller is further configured to estimate the distance from the reference position based on the intensity of the electric signals.

3. The apparatus of claim 2, further comprising:
a plurality of polarization filters including, at least, a first polarization filter corresponding to a first photoelectric device of the plurality of photoelectric devices and a second polarization filter corresponding to a second photoelectric device of the plurality of photoelectric devices
wherein a polarization direction of the first polarization filter is different from a polarization direction of the second polarization filter.

4. The apparatus of claim 3, wherein when estimating the distance from the reference position, the controller is further configured to compensate for the intensity of the electric signals received from the plurality of photoelectric devices based on information about the polarization direction of at least one of the plurality of polarization filters.

5. The apparatus of claim 3, wherein the controller is further configured to estimate an orientation angle of the device based on the intensity of the electric signals based on an oscillation direction of the light and the polarization direction of at least one of the plurality of polarization filters.

6. The apparatus of claim 5, wherein when estimating the orientation angle, the controller is further configured to scale the intensity of the electric signals based on an average value of the electric signals received from each of the plurality of photoelectric devices.

7. The apparatus of claim 3, wherein, the plurality of photoelectric devices is further configured to generate an electric signal with a delay corresponding to a difference in polarization directions between each of the plurality of polarization filters corresponding to the plurality of photoelectric devices such that the delay is based on a predetermined cycle for the at least one source of the light changing a polarization direction of the light.

8. The apparatus of claim 7, wherein the controller is further configured to receive data from the at least one source of the light and to determine the predetermined cycle based on a bit rate of the data received from the at least one source of the light.

9. The apparatus of claim 8, wherein
the data includes at least one of a position of the at least one source of the light, an identifier of the at least one source of the light, or information about an indoor space including the at least one source of the light.

10. The apparatus of claim 3, wherein
the plurality of photoelectric devices comprise n photoelectric devices, and
the polarity of polarization filters is configured such that polarization directions of each of the plurality of polarization filters corresponding to a photoelectric device, of the n photoelectric devices, are different from each other by π/n°.

11. A method for estimating a position of a device using an optical signal, the method comprising:
converting the optical signal into a plurality of electric signals using a plurality of photoelectric devices included in the device;
estimating a distance of the device from a reference position based on the plurality of electric signals; and
estimating an orientation angle of the device with respect to a reference direction based on the plurality of electric signals.

12. The method of claim 11, wherein the estimating the distance of the device from the reference position comprises:
determining a moving distance of an image cast by a lens assembly onto the plurality of photoelectric devices of a light source from which the optical signal is transmitted based on the electrical signals; and
estimating the distance of the device from the reference position based on at least two of a height of the light source, a distance between the lens assembly and the plurality of photoelectric devices, or the moving distance of the image.

13. The method of claim 12, wherein information on the height of the light source is included in data recovered by demodulating the optical signal.

14. The method of claim 12, wherein the determining of the moving distance of the image comprises:
determining an orthogonal coordinates of the image using at least one of a maximum value or an average value of the plurality of electric signals of respective channels connected to the plurality of photoelectric devices.

15. The method of claim 14, wherein the determining of the orthogonal coordinates of the image comprises:
determining the orthogonal coordinates of the image using the maximum value of the plurality of electric signals based on minimum values of the plurality of electric signals of the respective channels being not substantially the same; or
determining the orthogonal coordinates of the image using the average value of the plurality of electric signals based on minimum values of the plurality of electric signals of the respective channels being substantially the same.

16. The method of claim 11, wherein: the estimating of the orientation angle of the device comprises:
estimating the orientation angle based on intensities of the plurality of electric signals and a polarization direction of a polarization filter at each of the plurality of photoelectric devices.

17. The method of claim 11, wherein
the plurality of photoelectric devices comprises n photoelectric devices, and polarization directions of each of polarization filters corresponding to the n photoelectric devices are different from each other by π/n°.

18. The method of claim 17, further comprising:
compensating for intensities of the plurality of electric signals, before the estimating of the distance of the device from the reference position, based on the polarization directions of each of the polarization filters of the plurality of photoelectric device, and
wherein the estimating of the distance of the device from the reference position comprises estimating the distance of the device from the reference position based a result of the compensating of the intensities of the plurality of electric signals.

19. The method of claim 11, further comprising:
scaling intensities of the plurality of electric signals, before the estimating of the orientation angle, based on an average value of the plurality of electric signals received from each of the plurality of photoelectric devices, and
wherein the estimating of the orientation angle comprises estimating the orientation angle of the device with respect to the reference position based on a result of the scaling of the intensities of the plurality of electric signals.

20. An optical communication system estimating a position of a device, the optical communication system comprising:
a transmitting device configured to generate a light signal by modulating data and transmitting a linearly polarized light signal by modulating a polarization state of the light signal; and
a receiving device configured to
receive the linearly polarized light signal,
convert the received light signal into an electric signal using a plurality of photoelectric devices, and
estimate a position of the device using the electric signal transmitted through a plurality of channels connected to the plurality of photoelectric devices.
